(19) United States
(12) Patent Application Publication
(10) Pub. No.: US 2005/0066235 A1
(43) Pub. Date: Mar. 24, 2005

(54) Automated fault finding in repository management program code

(75) Inventor: Sven Lange-Last, Boeblingen (DE)

Correspondence Address: IBM CORPORATION;INTELLECTUAL PROPERTY LAW, 11400 BURNET ROAD, AUSTIN, TX, 78758, US

(73) Assignee: INTERNATIONAL BUSINESS MACHINES CORPORATION, ARMONK, NY (US)

(21) Appl. No.: 10/892,437

(22) Filed: Jul. 15, 2004

(30) Foreign Application Priority Data
Sep. 24, 2003 (EP) 03103546.2

(51) Int. Cl. G06F 11/00

(52) U.S. Cl. 714/38

(57) ABSTRACT

The present invention relates to a method and device for database management. In particular, the present invention relates to a method and system for fault finding in repository management code, in which a data repository is operated including a respective logging mechanism for write and read operations being processed on the data repository. In order to improve such fault finding in case of an inconsistency found in the repository, the present invention performs a repeated sequence of undoing a respective last operation and subsequent checking of the consistency of the repository until the repository is found consistent again. Subsequently the fault finding system redoes the last operation by a redo operation, and generates a diagnostic output including some debugging information which is usable for retrieving the one or more software instructions, for example in form of a call stack, which indicates a reason for the inconsistency that was found.

### BACKGROUND OF THE INVENTION

A. Field of the Invention

The present invention relates to a method and device for database management. In particular, the present invention relates to a method and system for automated fault finding in repository management code, in which a data repository is operated including a respective logging mechanism for write and read operations being processed on the data repository.

B. Description of the Prior Art

Most prior art software programs, which perform the management of data stored in such repositories, rely on the consistency of persistent data, which is stored on persistent media like a hard disk or a tape. If large amounts of data have to be stored persistently and need to be accessed fast, mature data structures are used to build a repository containing the persistent data. In order to allow fast access to the repository, the repository structure has to follow a set of rules as for example that all data is stored sequentially according to a key data field. But due to failures in the program product writing to the data repository, an update or modify operation on the repository might violate one or more of the consistency constraints mentioned above.

In prior art, usually there is a program code provided for checking the repository's consistency. But in general this checking code is too slow for running after each modification of the repository, so it is too expensive for a user thereof. In this way the inconsistency in the repository is not known until an after effect occurs or the consistency check is run. After a sequence of write operations followed after an inconsistency was brought in the data repository, it is extremely hard to determine exactly, which update operation caused said repository inconsistency.

In prior art the data repository is then repaired by a prior art called “point-in-time recovery” which offers the ability to restore any former repository state. The disadvantage is, however, that one cannot exclude for the future that the same or a similar inconsistency is brought again in the data repository.

Also prior art “journaling” technique cannot solve these problems: a journal stores in its plurality of entries any intended modifications to the data repository before they are actually performed and the repository is actually changed. This is done until a certain point of synchronisation is reached, corresponding to a state referred to simply as “journal is full”, and after a check of the entries present in the journal the data repository is updated, and the journal is written again from scratch. When for example a crash of a hard disk occurs, for instance when the journal is “half-full”, the last synchronisation point serves as a base for the data repository and a so-called “roll-forward-process” can be used for updating the data repository according to the contents stored in the journal. But again, data inconsistencies cannot be avoided and the actual reason, which caused the inconsistency in the data repository mentioned above, cannot be detected.

### SUMMARY OF THE INVENTION

It is thus an objective of the present invention to improve the management of data in such data repositories.

### SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to a basic aspect of the present invention, in case an inconsistency was found by an error-checking program, the following steps are performed:
performing a repeated sequence of undoing a respective last operation and subsequent checking of the consistency of the repository until the repository is found consistent again,
redoing the last operation by a redo operation, and (optionally)
generating a diagnostic output comprising some debugging information which is usable for retrieving the one or more software instructions, for example in form of a call stack, which gave reason to said found inconsistency.

Thus, the present invention allows for automatically determining the operation performed in the past, which corrupted the repository structure. The inventive improvement is based on the combination of two prior art techniques, i.e. the undo/redo and the repository check facilities, in order to allow for a post-mortem analysis of the repository program code. Due to the diagnostic output provided by the invention a software developer, who knows the repository management code, is able to detect the instruction at every program-language level, which caused the inconsistency. Thus, it is even possible to specifically add more checks to the checking program code, if a new kind of consistency rule shall be checked, which is intended to cover the actually found inconsistency. Even past operations can be checked against the new constraint. Further, a development-team can ask a customer, who uses the faulty data repository management code to use the automated fault finding program according to the invention with a specialized program code, which generates the diagnostic output mentioned before for the customer's problem at the customer site with the customers hardware. This is particularly useful to find out, if the inconsistency was introduced by a program code error or maybe by a hardware error only existing at the client side.

The present invention can be advantageously applied in order to improve performance in applications, the runtime of which is quite safety-critical, or the consistency-checking of which is quite complicated, as normally, consistency-checking code is quite slow.

Further, the present invention can be advantageously applied in relational databases or in hierarchical databases or for managing file systems, or for managing directory services like Lightweight Directory Access Protocol (“LDAP”) servers specified in IETF RFC 3377 or “ACTIVE DIRECTORY” by Microsoft™, disclosed in www.rfc-editor.org, or www.ietf.org etc.

Thus, the term “data repository” referred to in here generically refers to a central place where data is stored and maintained. Thus, a repository can be a place where multiple or a single database or files are located for distribution over a network, or such repository can be a location that is directly accessible to the user without having to travel across a network.

The basic idea of the invention combines two mechanisms:
1. The Undo/Redo operation and
2. The checking operation (mentioned above).

After a repository inconsistency was found, the Undo operation followed by a consistency check is repeated until the repository is sound again. The next operation—which can be performed by a Redo—is the one, which violated the consistency constraints.

The inventional principle of automated fault finding in repository management code makes the following actions possible, which are otherwise not possible in prior art. That is, the exact operation can be determined, and which was performed in the past, which violated a specific repository constraint. A new constraint can then be added to the checking code, which was not known to be important in the past.

Past operations can be checked against this new constraint.

The method of the present invention can be basically performed during the runtime of the operation of the data repository, i.e. when multiple users can access the repository. This is due to the fact that the code implementing the inventional method can be encapsulated in an operation as this is usually done with any write access to the repository.

Further, a user of the repository can be asked by a repository service team, to use the inventional automated fault-finding method with a specialized program code, which generates diagnostic output for the user's problem. In this way, an operation, which corrupts the repository only in the user's environment can be investigated, and future faults in repository management can be avoided.

### BRIEF DESCRIPTION OF THE DRAWINGS

The present invention is illustrated by way of example and is not limited by the shape of the figures of the drawings in which:

FIG. 1 is a schematic representation of an exemplary prior art system structure of an application with a persistent repository operated in a network, where the inventional method can be applied;

FIG. 2 is a schematic representation of two subsequent repository states and illustrating how the undo and redo operations from the operation log can be used to transform one state into the other;

FIG. 3 is a schematic representation of an AVL tree, initial state;

FIG. 4 is a schematic representation of an AVL tree, resulting from the correct insertion of a new node into the tree shown in FIG. 2;

FIG. 5 is a schematic representation of an AVL tree, resulting from the wrong insertion of a new node into the tree shown in FIG. 2;

FIG. 6 is a schematic representation of an AVL tree, resulting from L-rotating the node with ADDRESS 200/KEY=10 in the tree shown in FIG. 4;

FIG. 7 is a schematic representation of an AVL tree, resulting from R-rotating the node with ADDRESS 100/KEY=20 in the tree shown in FIG. 5;

FIG. 8 is a schematic representation showing basic elements of the control flow in a method according to a preferred aspect of the present invention.

### DETAILED DESCRIPTION OF THE PREFERRED EMBODIMENT

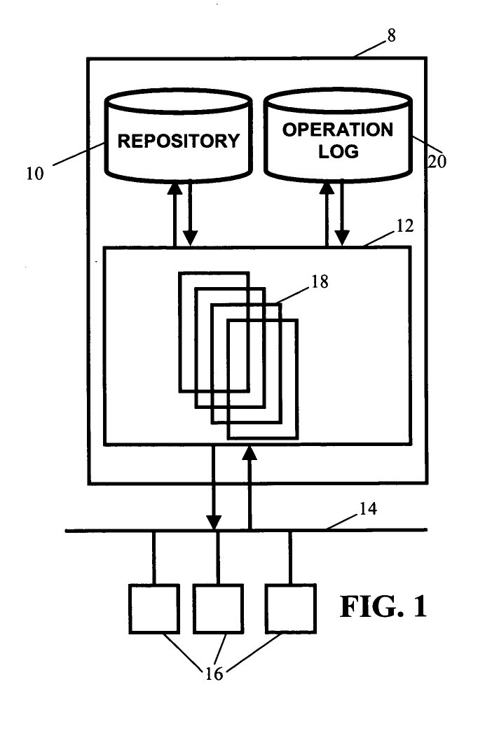

The present invention as illustrated by a method according to a preferred embodiment thereof can be run in a system, of which an exemplary structure is described next with reference to FIG. 1. Of course this system's structure is to be understood as only exemplarily, as the structure may be varied widely having the same practical usability of the inventional concept in all variations.

Most programs typically have a specialized data repository, which allows for fast access to and ensures persistency of data. The main purpose of programs like relational database management systems (RDBMS) is the provision of such a repository for other programs.

An RDBMS application 12 is to be understood exemplarily as a provider of a “data repository” 10 as used within this document. Datasets can be read from or written to the data repository 10 by aid of a respective RDBMS application, ie a software program 12 dedicated therefore. The RDBMS application is installed and running on a server computer 8. The data repository 10 is represented by data sets stored on some persistent media associated with the computer system 8. The RDBMS server 8 is a computer system, capable of processing said application with prior art dataset read or write requests incoming via a network 14 from multiple users each being associated with a respective RDBMS client application running on a client computer 16, of which are depicted three only. The number of users is not of essential interest relative to the present invention.

The before-mentioned RDBMS application software code 12 is assumed to be implemented according to the prior art, i.e. a large number of source code modules are compiled and linked in order to make a runtime version of the RDBMS application program. One or more of said software modules, say exactly one module depicted with reference sign 18 is now assumed to contain the software code, which is responsible for writing datasets to said repository. This module 18 is then referred to the “repository management code” in the sense of the present invention of course, as a person skilled in the art will appreciate that this module may split up inside into further subsections. The graphical representation of the splitting up is avoided in order to improve clarity of the drawing.

A prior art RDBMS may contain the “point-in-time recovery” capability which offers the ability to restore any former repository state. This capability may be implemented by use of an operation log 20. For each modification on the data repository 10 requested by a client 16, the operation log contains the operations to be performed by the RDBMS application 12 in order to carry out the modification and to remove the effects of the modification. This removal of a modification's effects is called “undo”. Re-establishing the effects of a modification which have been removed by an undo step is called “redo”. The repository management code 18 is responsible for maintaining the operation log 20. The operation log needs to be persistent and is therefore stored on some persistent media associated with the computer system 8.

Before describing the functional aspects of this preferred embodiment of the invention as applied exemplarily to Adelson-Velsky Landis (AVL) trees, a short and concise mathematical background is added in order to improve clarity of the inventional ideas given in here.

An AVL tree is a binary search tree with an additional constraint concerning the height of left and right subtree of each AVL tree's node. First of all, a tree contains nodes and edges, which connect the nodes. At most one edge may connect any two nodes directly. An edge connects exactly two nodes and cannot connect a node to itself. In a tree, each edge has associated a direction for traversal. For this reason, one can think of an edge as being an arrow emerging from one node and pointing to a second node. In a tree, at most one edge points to a node. The other way around, each node has at most one incoming edge. In a tree, all nodes are connected, i.e. each node can be reached from any other node by traversing intermediate edges and nodes while disregarding the associated direction of edges. In a tree, no cycles are allowed, i.e. there is exactly one way to get from any node in the tree to any other node.

It follows that exactly one node in the tree has no incoming edges—this node is called “root of the tree”. One or more nodes in the tree have no outgoing edges—these nodes are called “leaves of the tree”. If two nodes are connected by an edge, the one node where the edge begins is called “father node” of the connected node. If two nodes are connected by an edge, the one node where the edge ends is called “son node” of the connected father node.

A tree is a binary tree, if each father node has at most two son nodes. One son node is called the “left son” and the other is called the “right son”.

A tree's node may be used to store information. Two nodes of a tree may be compared regarding their information. For example, if English texts are stored as information, the alphabetical order of texts can be used to compare the information. In this way, one node is less or equal than another node. In a binary search tree, the left son is always less or equal than the father node and the father node is always less or equal than the right son.

In a tree, there is exactly one way for each leaf node to get from this node up to the root node. The number of nodes on this way (including the root and the leaf node) is called the “length”. In a tree, for one leaf node the way to the root node may be longer than for another leaf node. The height of a tree is the length of the longest possible way from a leaf node to the root node.

In a tree, a subtree is the tree, which would result from cutting off all incoming edges of a particular node and declaring this node as the root node of all nodes below it. In a binary tree, the left subtree of a node is the subtree which results from choosing the left son of the node in question as the root node of the subtree. In a binary tree, the right subtree of a node is defined analogously.

An AVL tree is a binary search tree where for each node of the tree, the height of the left and right subtrees differ by at most one. Inserting new nodes into or removing existing nodes from an AVL tree may violate this height difference constraint and thus degrade the former AVL tree to a binary search tree. There are operations defined on binary search trees, which transform binary search trees into AVL trees if the binary search trees meet certain conditions. These transformation operations are called “rotations”.

For more information on Adelson-Velsky Landis (AVL) trees, refer to D. E. Knuth: “The Art of Computer Programming—Volume 3—Sorting and Searching”, 2^{nd} edition, 1998, Addison Wesley Longman, pp. 458.

Next, the inventional concept of how to find errors or faults in the repository management code, compare to reference sign 18 in FIG. 1 is introduced by way of a theoretical approach, which is well suited due to its preciseness:

Let a set R be the set of all possible repository states, i.e., detailed “snapshots” showing all details of the content of the repository including any meta-information like access times to respective data entries, etc. The set R contains valid as well as invalid repository states.

Let a set O be the set of all possible operations on the repository, i.e. O is a mapping from R to R. It should be noted that (unfortunately) mappings o in O are not necessarily injective, which makes it impossible to generally deduce undo information from o itself.

Define “Redo” as the function, which “replays” a certain operation, i.e. Redo(o)=o.

Define “Undo” as the function, which makes the effects of an operation undone, i.e. Undo(o)(o(r))=r

Let “Valid” be a function mapping of R to {0, 1}, where Valid(r)=1 if the repository r is valid and Valid(r)=0 otherwise.

Let a set E be the set of all possible entries in an operation log. Entries e in E are 3-tuples with (o, Redo(o), Undo(o)) where o in O, Redo and Undo as defined above.

Let a set L be the operation log, i.e. a sequence of entries e in E. The sequence is written as L=e1 e2 . . . en.

Count(L) is the number of entries in L, i.e. Count(e1 e2 . . . en)=n. L(i)=ei, where L=e1 . . . ei . . . en and 1<=i<=n.

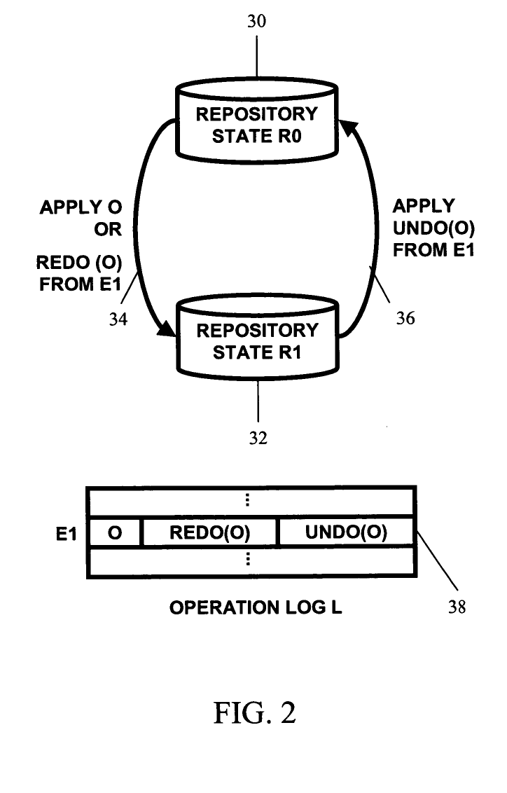

FIG. 2 shows the relationship between two subsequent repository states r0 30 and r1 32. An operation abbreviated as “o” is performed -34- on repository state r0 30 and thus transforms said repository to a new state r1 32. At the same time, the repository management code determines appropriate undo and redo operations and creates an entry E1 in the operation log 38. Whenever the repository is in state r1 (32), entry e1 from the operation log (38) can be used to determine the undo operation, which transforms the current repository to the state r0 (30) when applied (36). In the same way, the corresponding redo operation can be used to remove the effects of the undo operation.

As a person skilled in the art of computer science will appreciate, “automated fault finding” in repository management code according to the present invention can then be realized as follows:
A repository data structure is realized, which represents R, e.g. by using B-trees (see D. E. Knuth: “The Art of Computer Programming—Volume 3—Sorting and Searching”, 2^{nd} edition, 1998, Addison Wesley Longman, pp. 482) or AVL trees.

Operations are realized on the repository data structure representing O.

Also the “Valid” mapping is realized. This is well-understood in prior art computer science for all constraints which warrant the integrity of the repository data structure itself. The application using the repository for its data may need additional constraints to be checked.

Then an operation log L is realized. Whenever an operation o in O is performed, o is stored in the operation log. In addition, for every operation o the way is stored, how Undo(o) and Redo(o) can be realized.

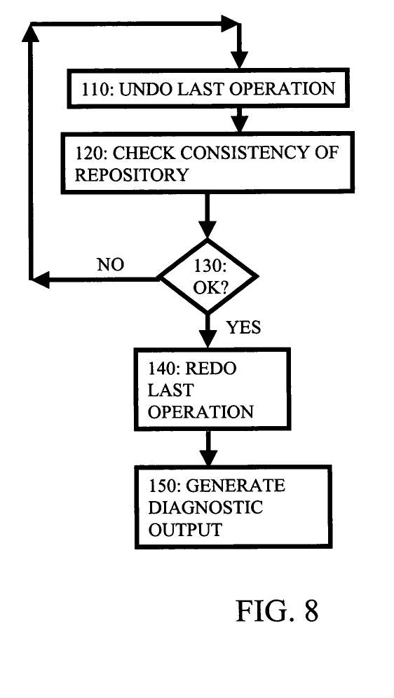

An exemplary algorithm for automated fault finding in repository management code can then implemented according to the following pseudo code, assuming a precondition: Valid(r)=0, where r in R is the current repository state. The control flow is depicted in FIG. 8 for reference:

i=Count (L);
IF Valid(r) = 1 THEN

Repository is currently valid.
EXIT;

END
found=FALSE;

| | |
|---|---|
| WHILE i>1 DO | This corresponds to the loop comprising steps 110 |
| | to 130. |

| e=L(i); | |
|---|---|
| Perform Undo(o) as defined in e; (step 110) | |
| DEC(i); | |
| IF Valid(r) = 1 THEN | This corresponds to the |
| | consistency check (step 120) and |
| | the decision (step 130). |

| | |
|---|---|
| found=TRUE; | |
| LEAVE WHILE; | This corresponds to the Yes branch of |
| | step 130. |

END

END

If the algorithm terminates with “found” set to TRUE, e=L(i), the operation, which violated the repository constraints according to the Valid mapping for the first time can be seen from the operation log. This operation can then be redone, step 140, and a diagnostic output can be generated including the call stack (set of operations performed on the data repository) which led to the wrong write process. Thus, the faulty instruction can be debugged according to prior art technique. If the error in repository management code has been found, said last operation can be redone using a corrected instruction in a Redo command, which makes the repository consistent again. As well, any further operations following in the operation log can be re-done to obtain any desired repository state—up to the corrected state in place when the inconsistency was discovered.

In other words, after the faulty operation was found any restore operation can be undertaken, the precise type of which depends on the particular case.

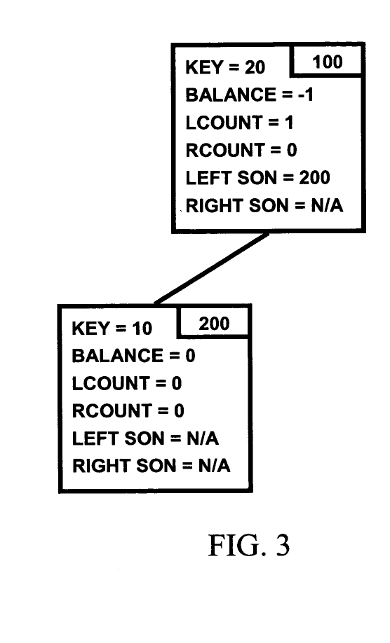

With general reference to the figures and with special reference now to FIG. 3 an exemplary application of a preferred embodiment of the present invention is described in more detail in an example of wrong insertion of a node in an AVL tree.

An exemplary tree node description is given by the definition elements KEY, BALANCE, LCOUNT, RCOUNT, LEFT SON, RIGHT SON.

The following assumptions might be defined to the above elements of the node definition:

The following definitions exist thereon:
KEY: Every node has a unique key.
BALANCE: The possible values and respective meaning are as follows:
   −1 if left subtree is higher than right subtree.
   0 if left and right subtrees have same height.
   +1 if right subtree is higher than left subtree.
LCOUNT/RCOUNT, i.e. left count, right count means the number of nodes in left/right subtree.
LEFT SON/RIGHT SON means the address of direct left/right son.
ADDRESS is the present node's address which is shown in the small rectangle in the right upper corner of the node's box as shown in FIG. 3 through FIG. 7.

The initial state is sketched in FIG. 3 and might be given as follows:
Node with KEY=20 was inserted first, has ADDRESS 100,
BALANCE=−1, because the left subtree has a height one and right subtree has height zero. It has a left subtree containing one node with KEY=10 and ADDRESS 200. This node is called “left son”.

The node with KEY=10 was inserted after node with KEY=20. It has no sons.

Then a new node is to be inserted having a KEY=30.

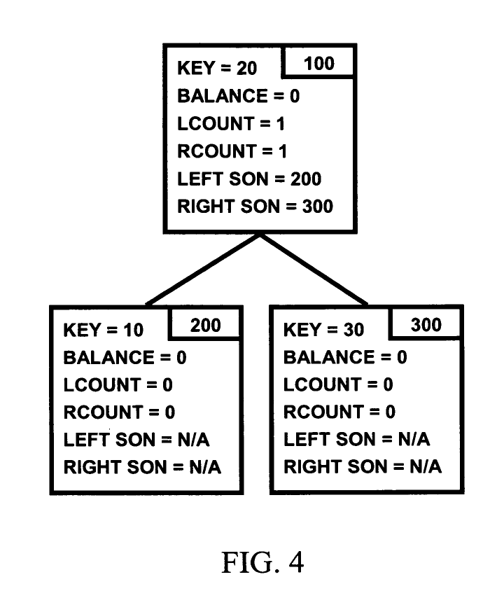

The correct insertion is shown in FIG. 4. It is based on the following scheme:
Compare new node's KEY=30 with root node's KEY=20 As 30 is greater than 20: Go to the root node's right son. There is no right son. Thus, the node with KEY=30 is the new right son. Set up new node. Follow the path from new node to root node and fix values, e.g. for BALANCE, LCOUNT, RCOUNT, etc.

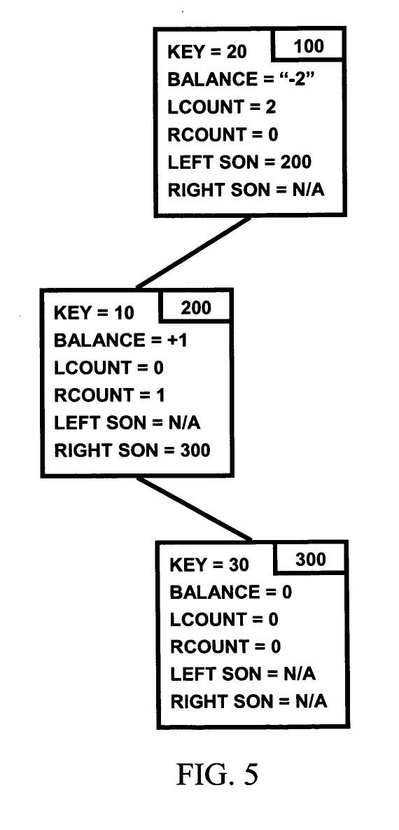

An exemplarily selected wrong insertion due to an assumed faulty repository management code is depicted in FIG. 5. The same new nodes as given above shall be inserted. The insertion is based on the following scheme:

Due to a programming error the node with ADDRESS 200/KEY=10 is assumed to be the root node—instead of the real root node with ADDRESS 100/KEY=20.

Compare the new node's KEY=30 with “root node's” KEY=10. As 30 is greater than 10: Go to the “root node's” right son. There is no right son. Thus, the node with KEY=30 is the new right son. Set up the new node as right son of node with ADDRESS 200/KEY=10.

Follow the path from new node to (real) root node and fix values, e.g. BALANCE, etc.

The node with ADDRESS 100/KEY=20 needs LR-rotation.

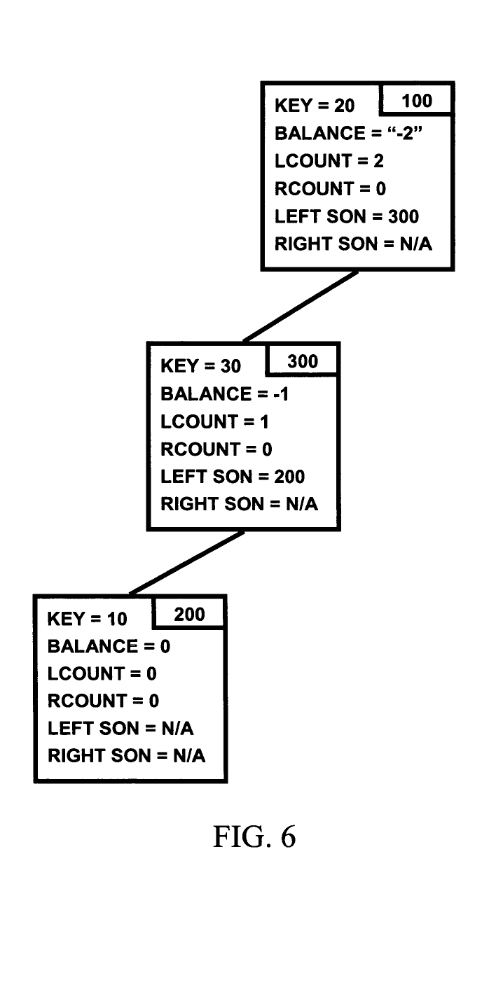

The state after having L-rotated the node with ADDRESS 200/KEY=10 is depicted in FIG. 6.

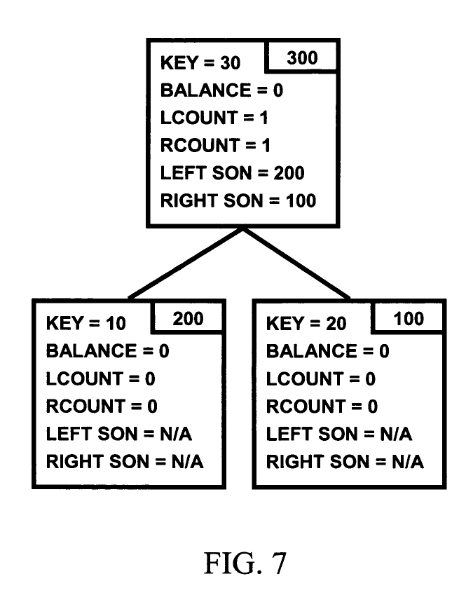

Also the node with ADDRESS 100/KEY=20 needs R-rotation (in order to complete the LR-rotation of node with ADDRESS 100/KEY=20). This is depicted in FIG. 7 showing the state after having R-rotated the node with ADDRESS 100/KEY=20.

Disadvantageously, the above wrong insertion yields that the node having KEY=20 can no more be found/removed as will be clear from the following scheme:
Search for KEY=20:
Compare KEY=20 with root node's KEY=30.
As 30 is greater than 20, this yields to continue with left son.
But there is only the node having KEY=10 to be found. Thus, the node will not be found by the standard tree search algorithm.
The full tree list, however, will contain the node having KEY=20. Thus, the above wrong insertion will be visible as an aftereffect.

The Log information accompanied by the foregoing insertion can be given as follows. Besides the operation performed and its corresponding undo and redo information, the Log contains a complete function call stack from the data/operation entry interface down to the lowest data repository management code:

Operation 1, 2003/11/07, 14:48:00:

Extended Call Stack Information:

(Two Digit Number Depicts Nesting Level)

Operation 1, 2003/11/07, 14:48:00:
Extended Call Stack Information:
(two digit number depicts nesting level)

| | |
|---|---|
| 01 | Function UserDialog( ): Operation Add, Key = 30 |
| 02 | Function AddNode (Key = 30): Determine if Key already exists |
| 03 | Function SearchNodeWithKey(Key = 30): Not found |
| 02 | Function AddNode (Key = 30): Add new Key |
| 02 | Function AddNode (Key =3 0): Determine insertion position |
| 03 | Function DetermineInsertionFatherNode (Key = 30): |

Father node ADDRESS 200 / KEY = 10

| | |
|---|---|
| 02 | Function AddNode (Key = 30): |

Insert as right son of node ADDRESS 200 / KEY = 10
New node: ADDRESS 300 / KEY = 30 / BALANCE = 0 /
LCOUNT = 0

RCOUNT = 0 / LEFT SON = N/A / RIGHT SON = N/A

Fixing nodes on path to root
ADDRESS 200 / KEY 10 / BALANCE = +1 / LCOUNT = 0 /

RCOUNT = 1 / LEFT SON = N/A / RIGHT SON = 300

ADDRESS 100 / KEY 20 / BALANCE = −2 / LCOUNT = 2 /

RCOUNT = 0 / LEFT SON = 200 / RIGHT SON = N/A

LR-rotate node ADDRESS 100 / KEY = 20

| | |
|---|---|
| 03 | Function PerformLRotation(ADDRESS 200) |
| 03 | Function PerformRRotation(ADDRESS 100) |

Redo information:
Insert Key = 30
Undo information:
L-rotate node ADDRESS 300 / KEY = 30
R-rotate node ADDRESS 300 / KEY = 30
Remove node ADDRESS 300 / KEY = 30 from node ADDRESS 200 /
KEY = 10

As will be appreciated by a person skilled in the art, the above-mentioned advantages will be present from the method of the described present invention.

The present invention can be realized in hardware, software, or a combination of hardware and software. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A method for automated fault finding in repository management code, the repository being operated in a processing infrastructure comprising a logging mechanism and undo and redo functionality for repository operations, comprising the steps of:
determining if an inconsistency was found in said repository management code;
a) when said inconsistency is found, undoing a respective last operation involving said repository management code;
b) checking the consistency of the repository management code until the repository is found to be consistent; and
c) redoing the last operation prior to the occurrence of said inconsistency.

2. The method according to claim 1, further comprising the step of:
generating an output including debugging information usable for retrieving a call stack, which caused said inconsistency.

3. The method according to claim 1, wherein said method is performed when said data repository is operating.

4. The method according to claim 1, further comprising the step of:
adding a predetermined number of redo steps, after the repository management code has been fixed, for restoring the repository.

5. A computer system having a functional component in a data processing system including a data repository operated in a processing infrastructure including a logging mechanism and undo and redo functionality for data repository operations, comprising:
a) means for performing an undo operation on a respective last operation performed on said data repository when an inconsistency is found in said data repository;
b) means for continually checking the consistency of the data repository after each undo operation until the data repository is determined to have consistent data;
c) means for performing a redo operation for the last data repository operation performed prior to said inconsistency being found in said data repository; and
d) means for generating an output including debugging information usable for retrieving a call stack, which includes at least one operation to said data repository that caused said found inconsistency to occur.

6. The computer system according to claim 5, further comprising:
means for generating an output including debugging information usable for retrieving a call stack, which includes at least one data repository operations that caused said found inconsistency.

7. The computer system according to claim 6, wherein said computer system determines whether an inconsistency exists while said data repository is operating.

8. The method according to claim 7, further comprising:
means for adding a predetermined number of redo steps, after the repository management code has been fixed, for restoring the repository.

9. A computer program for controlling a functional component in a data processing system, including a data repository operated in a processing infrastructure having a logging mechanism and undo and redo functionality for data repository operations, said computer program comprising to computer implemented steps of:
a) performing an undo operation on a respective last operation performed on said data repository when an inconsistency is found in said data repository;
b) continually checking the consistency of the data repository after each undo operation until the data repository is determined to have consistent data;
c) performing a redo operation for the last data repository operation performed prior to said inconsistency being found in said data repository; and
d) generating an output including debugging information usable for retrieving a call stack, which includes at least one operation to said data repository that caused said found inconsistency to occur.

10. A computer program product being executed on a data processing system having a functional component, including a data repository operated in a processing infrastructure having a logging mechanism and undo and redo functionality for data repository operations, said computer program product comprising the computer implemented instructions of:
a) means for performing an undo operation on a respective last operation performed on said data repository when an inconsistency is found in said data repository;
b) means for continually checking the consistency of the data repository after each undo operation until the data repository is determined to have consistent data;
c) means for performing a redo operation for the last data repository operation performed prior to said inconsistency being found in said data repository; and
d) means for generating an output including debugging information usable for retrieving a call stack, which includes at least one operation to said data repository that caused said found inconsistency to occur.
